(19) United States
(12) Patent Application Publication
(10) Pub. No.: US 2024/0360783 A1
(43) Pub. Date: Oct. 31, 2024

(54) MULTI-ENGINE SYNCHRONOUS DETECTION AND ANALYSIS SYSTEM

(71) Applicant: GUANGXI UNIVERSITY, Nanning (CN)

(72) Inventors: Kai YANG, Nanning (CN); Ying YANG, Nanning (CN); Shuaihu YANG, Nanning (CN); Min FENG, Nanning (CN)

(73) Assignee: GUANGXI UNIVERSITY, Nanning (CN)

(21) Appl. No.: 18/641,474

(22) Filed: Apr. 22, 2024

(30) Foreign Application Priority Data
Apr. 27, 2023 (CN) 2023104762395

(51) Int. Cl. F02B 77/08; G07C 5/00

(52) U.S. Cl. CPC F02B 77/083; G07C 5/006

(57) ABSTRACT

The invention presents a multi-engine synchronous detection and analysis system. It includes modules for inputting engine information, matching engine models, identifying fault locations, and processing faults. After maintenance, the system analyzes engine operation, stores data, and generates maintenance reports summarizing fault causes and locations. It optimizes the matching module based on regulatory outcomes. Using three-dimensional modeling and operational mechanisms, the invention evaluates engine state and predicts its lifespan. It summarizes components prone to failure across different engine types using historical and maintenance data.

### TECHNICAL FIELD

The invention belongs to the field of engine detection, especially relates to a multi-engine synchronous detection and analysis system.

### BACKGROUND ART

The engine is the power plant of the car, which provides strong power for the start and operation of the car, with the increase in vehicle mileage and years, various types of faults often occur in automobile engines, which affect the safety of automobile driving. With the development of electronic technology and the wide embodiment of various intelligent equipment, the model and structure of the engine become more and more complex, which brings great difficulties to fault diagnosis. At the same time, the existing engine detection technology can not effectively realize the synchronous detection of multiple engines and the accurate evaluation of the state of each component of the engine.

### SUMMARY

The purpose of the invention is to disclose a multi-engine synchronous detection and analysis system to solve the problems existing in the above-existing technologies.

In order to achieve the above purpose, the invention provides a multi-engine synchronous detection and analysis system, comprising an information input module, an information matching module, a fault processing module, an operation analysis module, a data repository, and a maintenance report module connected in turn;
the information input module is used to input information of several types of engines;
the information matching module is used to match an engine model according to engine information and identify a fault location of the engine;
the fault processing module is used to perform fault maintenance according to matching results and identification results of the information matching module;
the operation analysis module is used to analyze a normal operation state of the engine after maintenance, generate and display an analysis report;
the data repository is used to store the engine information, the matching result, the recognition result and the analysis report, the data repository also stores appearance images of different types of engines;
the maintenance report module is used to summarize, regulate, and display fault causes and fault parts of different types of engines according to stored data in the data repository, and optimize the information matching module according to a regulated result.

Optionally, the engine information comprises several different engine models, engine images, duration of use, maintenance history, fault state characterization, fault occurrence time, and fault occurrence scenarios.

Optionally, the information matching module retrieves the images of the same engines stored in the data repository according to the engine model in the engine information, and performs a similarity matching between the images of the same engines and the engine images in the engine information;
the information matching module determines a system part of an engine failure according to a fault state representation and a fault occurrence scene in the engine information, and judges an influence degree of the fault according to a use time, maintenance history, and fault occurrence time.

Optionally, when there is no engine image matching with the engine model in the data repository, carrying out a search online according to the engine model by the information matching module, and setting a similarity threshold according to a corresponding engine image, when a similarity between an image obtained by a search result and an image uploaded in the engine information reaches the similarity threshold, storing an image obtained by the search result as the engine image.

Optionally, a maintenance function of the fault processing module comprises ignition system maintenance, fuel injector maintenance, fuel pump maintenance, cylinder maintenance, and intake system maintenance;
the ignition system maintenance comprises high voltage line replacement, spark plug replacement, spark plug cleaning, and distributor maintenance; the fuel injector maintenance comprises injector cleaning, injector replacement, and injector line maintenance; the fuel pump maintenance comprises fuel pump diaphragm replacement and relay replacement; the cylinder maintenance comprises cylinder leakage repair and cylinder replacement; the intake system maintenance comprises sensor replacement, one-way valve replacement, and piston cleaning.

Optionally, the operation analysis module carries out three-dimensional modeling and meshing of the engine under normal operating conditions to obtain the engine model; an engine operation mechanism is analyzed according to the engine model, system components of the engine are simulated, and an upper and lower computer system is used to analyze and correct wear of engine system components, and a life prediction of each system component is carried out according to the engine operation mechanism, and the analysis report is generated.

Optionally, the data repository is classified and stored respectively according to the identification results and the analysis reports of the engine model at different times, and the analysis reports of the same component of different types of engines are unified.

Optionally, the maintenance report module summarizes components that are prone to failure of different types of engines according to the identification results and analysis reports classified and stored by the data repository, and generates summary results, the information matching module is used to preferentially identify the components that are prone to failure of the engines according to the summary results, and the same component analysis report of different types of engines in the data repository is extracted, an operation stability of different types of engines is evaluated according to a life prediction result of the same type of components in the analysis report to generate evaluation results.

The technical effect of the invention is as follows:

The invention can realize synchronous detection of different types of engines, improve the accuracy of fault identification through engine model and image matching, and realize engine operation state evaluation and life prediction through three-dimensional modeling and operation mechanism of each component of the engine. The components of different types of engines that are more prone to failure are summarized and a summary is carried out according to the historical analysis data and maintenance data, so that users can take measures in advance before the engine failure occurs to avoid danger.

### BRIEF DESCRIPTION OF THE DRAWINGS

The drawings that form a part of this invention are used to provide further understanding of this invention, the schematic embodiments and descriptions are used to explain this invention and do not constitute an improper qualification of this invention. In the attached FIGURE:

FIG. 1 is a schematic diagram of the structure of the multi-engine synchronous detection and analysis system in the embodiment of the invention.

### DETAILED DESCRIPTION OF THE EMBODIMENTS

It should be noted that the implementation examples in this embodiment and the characteristics of the embodiment can be combined without conflicts, this embodiment is explained in detail by referring to the combination of the attached FIGURE and the implementation examples in the following.

It should be noted that the steps shown in the flow chart attached to the FIGURE can be executed in a computer system such as a set of computer-executable instructions, and although the logical order is shown in the flow chart, the steps shown or described can be executed in a different order from here in some cases.

### Embodiment 1

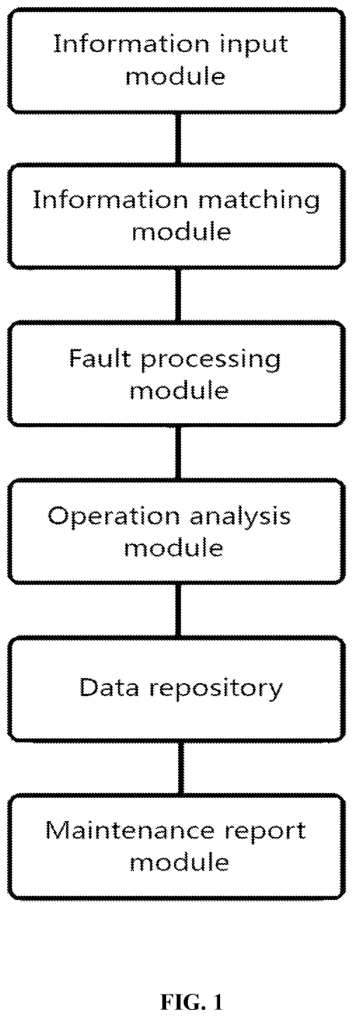

As shown in FIG. 1, the invention provides a multi-engine synchronous detection and analysis system, comprising an information input module, an information matching module, a fault processing module, an operation analysis module, a data repository, and a maintenance report module;
the information input module is used to input information of several types of engines; where the engine information comprises several different engine models, engine images, duration of use, maintenance history, fault state characterization, fault occurrence time, and fault occurrence scenarios of several different engines.
the information matching module is used to match the engine model according to the engine information and identify the fault location of the engine;
the fault processing module is used to perform fault maintenance according to matching results and identification results of the information matching module;
the operation analysis module is used to analyze the normal operation state of the engine after maintenance, generate and display the analysis report;
the data repository is used to store the engine information, the matching result, the recognition result and the analysis report, the data repository also stores appearance images of different types of engines;
the maintenance report module is used to summarize, regulate, and display fault causes and fault parts of different types of engines according to stored data in the data repository, and optimize the information matching module according to the regulated result.

As a better implementation method of this embodiment, the information matching module retrieves the images of the same engines stored in the data repository according to the engine model in the engine information, and performs the similarity matching between the images of the same engines and the engine images in the engine information;
the information matching module determines the system part of the engine failure according to the fault state representation and the fault occurrence scene in the engine information, and judges the influence degree of the fault according to the use time, maintenance history, and fault occurrence time.

As a better implementation method of this embodiment, when there is no engine image matching with the engine model in the data repository, the information matching module carries out a search online according to the engine model, and sets a similarity threshold according to the corresponding engine image, when the similarity between the image obtained by a search result and an image uploaded in the engine information reaches the similarity threshold, the image obtained by the search result is stored as the engine image.

As a better implementation method of this embodiment, the maintenance function of the fault processing module comprises ignition system maintenance, fuel injector maintenance, fuel pump maintenance, cylinder maintenance, and intake system maintenance;
the ignition system maintenance comprises high voltage line replacement, spark plug replacement, spark plug cleaning, and distributor maintenance; the fuel injector maintenance comprises injector cleaning, injector replacement, and injector line maintenance; the fuel pump maintenance comprises fuel pump diaphragm replacement and relay replacement; the cylinder maintenance comprises cylinder leakage repair and cylinder replacement; the intake system maintenance comprises sensor replacement, one-way valve replacement, and piston cleaning.

As a better implementation method of this embodiment, the operation analysis module carries out three-dimensional modeling and meshing of the engine under normal operating conditions to obtain the engine model; the engine operation mechanism is analyzed according to the engine model, the system components of the engine are simulated, and the upper and lower computer system is used to analyze and correct wear of engine system components, and the life prediction of each system component is carried out according to the engine operation mechanism, and the analysis report is generated.

As a better implementation method of this embodiment, the data repository is classified and stored respectively according to the identification results and the analysis reports of the engine model at different times, and the analysis reports of the same component of different types of engines are unified.

As a better implementation method of this embodiment, the maintenance report module summarizes components that are prone to failure of different types of engines according to the identification results and analysis reports classified and stored by the data repository, and generates summary results, the information matching module is used to preferentially identify the components that are prone to the failure of the engines according to the summary results, and the same component analysis report of different types of engines in the data repository is extracted, an operation stability of different types of engines is evaluated according to a life prediction result of the same type of components in the analysis report to generate evaluation results.

Technicians in this field should understand that the embodiment of the invention can be provided as a system, or a computer program product. Therefore, the invention can be in the form of a complete hardware embodiment, a complete software embodiment, or a combination of software and hardware embodiments. Moreover, the invention can be used in the form of a computer program product implemented on one or more computer-available storage media (including but not limited to disk storage, CD-ROM, optical storage, etc.) containing computer-available program code.

The invention is described by reference to the flow chart and/or block diagram of the computer program product according to the embodiment of the invention. It should be understood that each process and/or box in a flowchart and/or block diagram, and the combination of processes and/or boxes in a flowchart and/or block diagram, can be implemented by computer program instructions. These computer program instructions can be provided to general-purpose computers, special-purpose computers, embedded processors, or processors of other programmable data processing devices to generate a machine, so that instructions executed by processors of computers or other programmable data processing devices are generated to implement a process or multiple processes in the flow chart. And/or a box in the block diagram or multiple boxes specify the function of the device.

These computer program instructions can also be stored in a computer-readable memory that can guide a computer or other programmable data processing equipment to work in a specific way so that the instructions stored in the computer-readable memory produce a manufactured product including an instruction device, which implements a function specified in a flow chart or multiple processes and/or a block diagram or multiple boxes.

These computer program instructions can also be loaded onto a computer or other programmable data processing device so that a series of operation steps are performed on the computer or other programmable device to generate computer-implemented processing so that the instructions executed on the computer or other programmable device provide the steps for implementing the functions specified in a flow chart or multiple processes and/or a block diagram or multiple blocks.

The above content is only the better implementation methods of this embodiment, but the scope of protection of this embodiment is not limited to the implementation methods, any changes or replacements that can be easily imagined by technical personnel familiar with this technical field within the technical scope disclosed in this embodiment should be covered by the scope of protection of this embodiment. Therefore, the scope of protection of this embodiment should be based on the scope of protection of claims.

What is claimed is:

1. A multi-engine synchronous detection and analysis system, comprising an information input module, an information matching module, a fault processing module, an operation analysis module, a data repository, and a maintenance report module connected in turn;
the information input module is used to input information of several types of engines;
the information matching module is used to match an engine model according to engine information and identify a fault location of the engine;
the fault processing module is used to perform fault maintenance according to matching results and identification results of the information matching module;
the operation analysis module is used to analyze a normal operation state of the engine after maintenance, generate and display an analysis report;
the data repository is used to store the engine information, the matching result, the recognition result and the analysis report, the data repository also stores appearance images of different types of engines;
the maintenance report module is used to summarize, regulate, and display fault causes and fault parts of different types of engines according to stored data in the data repository, and optimize the information matching module according to a regulated result.

2. The multi-engine synchronous detection and analysis system according to claim 1, wherein the engine information comprises several different engine models, engine images, duration of use, maintenance history, fault state characterization, fault occurrence time, and fault occurrence scenarios.

3. The multi-engine synchronous detection and analysis system according to claim 1, wherein the information matching module retrieves images of the same engines stored in the data repository according to the engine model in the engine information, and performs a similarity matching between the images of the same engines and the engine images in the engine information;
the information matching module determines a system part of an engine failure according to a fault state representation and a fault occurrence scene in the engine information, and judges an influence degree of a fault according to a use time, maintenance history, and fault occurrence time.

4. The multi-engine synchronous detection and analysis system according to claim 1, wherein when there is no engine image matching with the engine model in the data repository, carrying out a search online according to the engine model by the information matching module, and setting a similarity threshold according to a corresponding engine image, when a similarity between an image obtained by a search result and an image uploaded in the engine information reaches the similarity threshold, storing an image obtained by the search result as the engine image.

5. The multi-engine synchronous detection and analysis system according to claim 1, wherein a maintenance function of the fault processing module comprises ignition system maintenance, fuel injector maintenance, fuel pump maintenance, cylinder maintenance, and intake system maintenance;
the ignition system maintenance comprises high voltage line replacement, spark plug replacement, spark plug cleaning, and distributor maintenance; the fuel injector maintenance comprises injector cleaning, injector replacement, and injector line maintenance; the fuel pump maintenance comprises fuel pump diaphragm replacement and relay replacement; the cylinder maintenance comprises cylinder leakage repair and cylinder replacement; the intake system maintenance comprises sensor replacement, one-way valve replacement, and piston cleaning.

6. The multi-engine synchronous detection and analysis system according to claim 1, wherein the operation analysis module carries out three-dimensional modeling and meshing of the engine under normal operating conditions to obtain the engine model; an engine operation mechanism is analyzed according to the engine model, system components of the engine are simulated, and an upper and lower computer system is used to analyze and correct wear of engine system components, and a life prediction of each system component is carried out according to the engine operation mechanism, and the analysis report is generated.

7. The multi-engine synchronous detection and analysis system according to claim 1, wherein the data repository is classified and stored respectively according to the identification results and the analysis reports of the engine model at different times, and the analysis reports of the same component of different types of engines are unified.

8. The multi-engine synchronous detection and analysis system according to claim 1, wherein the maintenance report module summarizes components that are prone to failure of different types of engines according to the identification results and analysis reports classified and stored by the data repository, and generates summary results, the information matching module is used to preferentially identify the components that are prone to failure of the engines according to the summary results, and the same component analysis report of different types of engines in the data repository is extracted, an operation stability of different types of engines is evaluated according to a life prediction result of the same type of components in the analysis report to generate evaluation results.
